(19) United States
(12) Patent Application Publication
(10) Pub. No.: US 2019/0009428 A1
(43) Pub. Date: Jan. 10, 2019

(54) 3D PRINTING OF BUILDING ELEMENTS AND BUILDINGS WITH BCT CEMENT

(71) Applicant: HEIDELBERGCEMENT AG, Heidelberg (DE)

(72) Inventors: WOLFGANG DIENEMANN, MAUER (DE); KAI WORTMANN, HOLZMINDEN (DE)

(73) Assignee: HEIDELBERGCEMENT AG, Heidelberg (DE)

(21) Appl. No.: 15/752,441

(22) PCT Filed: Sep. 10, 2016
(86) PCT No.: PCT/EP2016/001527

§ 371 Date: Feb. 13, 2018

(30) Foreign Application Priority Data
Sep. 22, 2015 (EP) 15002730.8

(51) Int. Cl. B28B 1/00; C04B 28/06

(52) U.S. Cl. CPC B28B 1/001; C04B 2111/00181; C04B 28/065

(57) ABSTRACT

The present invention relates to the use of belite calcium sulfoaluminate ternesite cement for the production of components and buildings by means of 3D printing and a method for the production of components and buildings by the 3D printing of belite calcium sulfoaluminate ternesite cement.

The present invention relates to the use of belite calcium sulfoaluminate ternesite (BCT) cement for the production of building elements and buildings by means of 3D printing and a method for the production of building elements and buildings by means of 3D printing of BCT cement.

3D printing has been developed in the context of the rapid prototyping methods, i.e. for manufacturing methods which aim to convert existing CAD data directly and quickly as for as possible without manual steps or moulds into prototypes or workpieces. In rapid prototyping, the workpiece is generally built up in layers from shapeless or neutrally shaped material using physical and/or chemical effects.

In addition to the production of prototypes, the manufacturing of end products is also gaining importance. Using the term contour crafting, Prof. Behrokh Khoshnevis in the USA proposed the use of 3D printing for the production of buildings. Here, the outer contours of the walls are printed in layers with quick-set cement and the intermediate space is filled with normal concrete, optionally after the insertion of reinforcement. This approach is costly.

In China, Ma Yihe developed a system in which building elements such as walls and ceilings are printed and then mounted to form the building in a similar manner as in prefabricated buildings, see, among others, CN 104372884 A, CN 204081129 U and CN 203654462 U. The construction of a villa made from such elements has been reported e.g. by W. Kempkens on www.ingenieur.de on 31 Jan. 2015 using the title “Chinesische Ingenieure bauen Villa mit 3D-Drucker” [Chinese engineers build villa with 3D printer].

A proposal for a cement mixture which is suitable as a building material for 3D printing can be found in CN 104310918 A. Accordingly, the building material should comprise 33-44% cement, 0-8% inorganic powder, 32-38% special sand, 2.5-3% polymer and a blend of admixtures. A blend of calcium sulfoaluminate cement and Portland cement is used as cement. The disadvantage of this is that the complex admixture blend and the additives polymer and inorganic powder must be continuously adapted to the current cement quality, and the required amounts of admixture and polymer also make the building materials relatively expensive.

Therefore, the problem is that the costs or effort for widespread use are still too high with the techniques/building materials that are currently used. Accordingly, it was an object of the invention to provide a cheaper and/or simpler building material.

Surprisingly, it has now been found that a BCT cement, if little or no retarder is added, develops both a sufficient early strength and a useful final strength and is suitable as a building material for 3D printing of components and buildings without complex admixture blends.

The above object is therefore solved by the use of BCT cement for the 3D printing of building elements and buildings; and by a method for the production of building elements and buildings, comprising the steps of providing BCT cement and the 3D printing of the building elements or building.

In order to simplify the further description, the following abbreviations which are common in the cement industry are used: H—H₂O, C—CaO, A—Al₂O₃, F—Fe₂O₃, M—MgO, S—SiO₂ and $-SO₃. In addition, compounds are usually specified in their pure form, without explicit specification of mixed series/substitution by foreign ions etc. as are common in technical and industrial materials. As any person skilled in the art understands, the composition of the compounds mentioned by name in this invention, such as, for example, clinker phases, can vary depending on the chemistry of the raw meal and the type of production, by substitution with various foreign ions. Such compounds are comprised within the scope of the invention when referring to the pure form, unless otherwise stated.

Unless otherwise stated, “reactive” means hydraulic reactivity.

In the context of the present invention, clinker means a sintered product which is obtained by burning a starting material at an increased temperature and contains at least one hydraulically reactive phase. Burning means activation by changing one or more of the properties of chemistry, crystallinity, phase composition, three-dimensional arrangement and binding behaviour of the framework atoms by supplying thermal energy. In individual cases, the starting material may also be a single raw material if it contains all the desired substances in the correct proportions, but this is the exception. The starting material may also contain mineralisers. Mineralisers are materials which act as fluxes and/or lower the temperature, which is necessary for the formation of a molten mass, and/or those which promote the formation of the clinker compound, for example by the formation of mixed crystals and/or by phase stabilisation. Mineralisers may be contained in the starting material as a component or added in a targeted manner.

Cement refers to a clinker which is ground with or without the addition of other components, but also to other hydraulically hardening materials and mixtures, for example, but not exclusively, supersulphated cement, geopolymer cement and belite cement obtained by hydrothermal conversion. Binder or binder mixture refers to a material which hydraulically hardens upon contact with water and which contains cement and typically, but not necessarily, further finely ground components. The binder comes into use as a building material after the addition of water, usually also aggregate and optionally admixtures.

Supplementary cementitious material or SCM refers to a pozzolanic and/or latent hydraulic material that replaces a part of the clinker in a cement or a binder. Latent hydraulic materials have a composition which enables hydraulic hardening upon contact with water, wherein an activator is typically required for hardening in technically useable periods. Activator or stimulator means a material which accelerates the hardening of latent hydraulic materials. It may be an addition such as sulphate or calcium (hydr)oxide and/or products from the hydraulic reaction of the clinker, e.g. calcium silicates release calcium hydroxide during hardening, which acts as an activator. Pozzolanic materials are characterised by a content of reactive silicon dioxide which, upon hydration of a binder with calcium hydroxide present in the aqueous phase, is converted into strength-forming calcium silicate hydrate phases. In practice, the boundary between latent hydraulic and pozzolanic materials is not well defined, e.g. depending on the content of calcium oxide, fly ashes may be pozzolanic or latent hydraulic materials. SCM refers to both latent hydraulic and pozzolanic materials. However, unreactive mineral additions such as rock flour, which have no part in the hydraulic conversion of the binder, should be distinguished from SCM. Sometime, SCM are summarized with such additions as mineral additives.

A clinker may already contain all necessary or desired phases and be used as a binder directly after grinding to form cement. The composition of the binder is often obtained by mixing cement and further components, according to the invention at least the supplementary cementitious material, and also two or more clinkers and/or cements are possible, wherein the mixing takes place before (or during) grinding and/or in the ground state and/or during the production of the binder. Unless a time of mixing is specifically stated, the following descriptions refer to binders (and cements) which are not limited in this respect.

BCT cement is known as such. Its production is described, for example, in WO 2013/023731 A1 and WO 2013/023729 A1, BCT cements in WO 2013/023728 A1. In summary, either a separate production of a ternesite cement and mixing with a calcium sulfoaluminate cement (C$A) can take place or the production of a BCT cement can take place in a two-stage process of sintering and tempering. In the two-stage production, a raw meal mixture of suitable composition is first sintered above 1200° C. to achieve good conversion of the starting materials and to form sufficient C₄A₃$ (ye'elimite) and C₂S (belite). In the second step, the clinker intermediate product is tempered in a temperature range from 1200 to 750° C. to obtain sufficient amounts of C₅S₂$ (ternesite). If separate production of C$A and ternesite cement takes place, the C$A can be made in a known manner. The ternesite cement is made separately from this by sintering a suitable raw meal at a temperature that is optimised for high ternesite content and does not have to take into account the ye'elimite and belite content. C$A can of course also be added to the BCT cement produced in the two-stage method in order to optimise the composition. BCT cement produced in a different manner is of course also suitable for the use and the method according to the present invention.

The BCT clinker obtained in the two-stage method usually contains the following main phases:

5 to 75% by weight C₅S₂$

5 to 70% by weight C₄A₃$ and

1 to 80% by weight C₂S.

Calcium silicates, sulphates, calcium aluminates, spinels, representatives of the melilite group, periclase, free lime, quartz and/or a glass phase are for example present as secondary phases preferably in a proportion of 0.1% by weight to 30% by weight, preferably 5% by weight to 20% by weight and particularly preferred from 10% by weight to 15% by weight. The type and amount of the one or more secondary phases in relation to the main components can be controlled by the weight ratios CaO/Al₂O₃(±Fe₂O₃), CaO/SiO₂ and the proportion of the sulphate carrier in the raw meal mixture. A preferred secondary phase is C₂A_{y}F_{1-y}, with y being from 0.2 to 0.8, preferably from 0.4 to 0.6, especially in the form C₄AF, which is preferably present in an amount of 3 to 30% by weight, particularly preferred from 5 to 25% by weight, and most preferably from 10 to 20% by weight. The BCT clinker preferably contains the following amounts of the main phases: 10-60% by weight, in particular 20-40% by weight C₅S₂$, 10-60% by weight, in particular 20-45% by weight. C₄A₃$ and 10-65% by weight, in particular 20-50% by weight C₂S. The free lime content is preferably below 5% by weight, in particular below 2% by weight and most preferably below 1% by weight. There may preferably be an X-ray amorphous phase or glass phase in an amount of 1 to 10% by weight, preferably 2 to 8% by weight and in particular 3 to 5% by weight. The proportions refer to the total amount of clinker, wherein in each clinker the total of all phases contained is 100%.

A separately produced ternesite clinker generally comprises

20 to 95% by weight C₅S₂$

0 to 15% by weight C₄A₃$

0 to 30% by weight C₄AF

0 to 20% by weight reactive aluminate

0 to 25% by weight periclase and

0 to 30% by weight further secondary phases.

Alkali/alkaline earth sulphates, quartzes, spinels, olivines, pyroxenes, representatives of the melilite and merwinite group, apatites, ellestadites, silicocarnotite, free lime, spurrite, quartz and/or an X-ray amorphous phase/a glass phase, for example, but not exclusively occur as further secondary phases in a proportion of 0.1% by weight-30% by weight, preferably from 2% by weight-20% by weight and particularly preferred from 5% by weight-15% by weight. The ternesite clinker preferably contains the following amounts of said phases: 30-95% by weight, in particular 40-90% by weight C₅S₂$, 3-12% by weight, in particular 5-10% by weight C₄A₃$ and 5-70% by weight, in particular 10-60% by weight of C₂S, 5-20% by weight, in particular 8-15% by weight of C₂(A_{y}F_{(1-y)}), 1-15% by weight, in particular 3-10% by weight reactive aluminates (e.g. C₃A, CA, C₁₂A₇ . . . ) and 1-15% by weight, in particular 2-10% by weight peridcase. The free lime content of the clinker is below 5% by weight, preferably below 2% by weight and particularly preferred below 1% by weight. In a preferred embodiment, the ternesite clinker contains 1-10% by weight, preferably 2-8% by weight and more preferably 3-5% by weight of at least one of an X-ray amorphous phase/a glass phase.

Raw materials which provide at least CaO, SiO₂ and, for BCT clinker, also provide Al₂O₃, are used for the production of BCT and ternesite clinkers. Secondary raw materials are preferably used at least partially in order to put them to an advantageous use and preserve natural resources. Suitable raw materials include, but are not limited to, for example, limestone, bauxite, clay/claystone, basalts, periodites, dunites, ingnimbrites, carbonatites, ashes/slags/high and low quality granulated slags (mineralogy/glass content, reactivity, etc.), various stockpile materials, red and brown muds, natural sulphate carriers, desulphurisation muds, phosphogypsum, etc. Since the raw materials which provide Al₂O₃ almost always also contain Fe₂O₃, ye'elimite is normally present in the form of C₄(AₓF₁₋ₓ)₃$ with x being from 0.1 to 1, preferably from 0.8 to 0.95, which is advantageous because the mixed phase with iron is particularly reactive.

Suitable C$A can be produced in a known manner and are also commercially available, for example:

### Lafarge Aether®:

Belite (α; +/−β) C₂S 40-75%; Ye'elimite C₄A$ 15-35%;
Ferrite C₂(A,F) 5-25%; Secondary phases 0.1-10%

### Lafarge Rockfast®:

Belite (α; +/−β) C₂S 0-10%; Ye'elimite C₄A₃$ 50-65%

### Aluminate CA 10-25%; Gehlenite C₂AS 10-25%;

Ferrite C₂(A,F) 0-10%; Secondary phases 0-10%

### Italcementi Allpre®:

Belite (α; +/−β) C₂S 10-25%; Ye'elimite C₄A₃$ 50-65%;
Anhydrite C$ 0-25%; Secondary phases 1-20%

### Cemex CSA:

Belite (α; +/−β) C₂S 10-30%; Ye'elimite C₄A₃$ 20-40%

### Anhydrite C$ >1%; Alite C₃S >1-30%;

Free lime CaO <0.5-6%; Portlandite Ca(OH)₂ 0-7%:
Secondary phases 0-10%

### Denka® CSA

Belite (α; +/−β) C₂S 0-10%; Ye'elimite C₄A₃$ 15-25%;
Anhydrite C₂(A,F) 30-40%; Portlandite Ca(OH)₂ 20-35%;
Free lime CaO 1-10%; Secondary phases 0-10%

### China Type II & III CSA

Belite (α; +/−β) C₂S 10-25%; Ye'elimite C₄A₃$ 60-70%;
Ferrite C₂(A,F) 1-15%; Secondary phases 1-15%

### Barnstone CSA

Belite (α; +/−β) C₂S 22%; Ye'elimite C₄A₃$ 60%;
Aluminate C₁₂A₇ 5%; Alite C₃S 8%;
Ferrite C₂(A,F) 4%; Secondary phases 1%.

These C$A cements partially contain ternesite as a secondary phase, but generally (far) too little. In addition, a separately produced ternesite is usually more reactive since it has been sintered at a lower temperature. Therefore, in order to provide the BCT cement used according to the invention, preferably, a mixture of C$A and ternesite cement is produced or a BCT cement created in the two-step process is used.

Typical compositions for preferred BCT cements are displayed in comparison with Portland cement (OPC) in the following table.

TABLE 1

| Phase | | OPO | BCT for 3D printing |
|---|---|---|---|
| C₃S | Alite | 55-75% | |
| C₂S | Belite | 10-20% | 40-60% |
| C₃A | Tricalcium aluminate | 5-10% | as secondary phase |
| C₄AF/C₂F | Ferrite | 5-10% | 5-15% |
| C₄A₃$ | Ye'elimite | | 20-70% |
| C₅S₂$ | Ternesite | | 5-20% |

| | | |
|---|---|---|
| Secondary phases | 0-5% | 0-10% |

While alite is responsible for early strength in Portland cement, optionally with the addition of C$A also ye'elimite, the fast strength development within 2 days in BCT cement is based on the ye'elimite alone. According to the invention, its proportion must therefore not be too low and is at least 20% by weight. Temesite and belite are crucial for final strength after 28 days and more. At least 40% by weight belite and at least 5% by weight ternesite should be contained. One advantage of BCT technology is the higher reactivity of ternesite compared to belite in OPC. In some cases, a high conversion can be detected during hydration after just 24 hours.

Due to the very high reactivity of ye'elimite, BCT cements have a similarly shortened open time to Portland cement which does not contain gypsum as a retarder. Time periods measured in laboratory tests range from around one minute to 20 minutes. In contrast to Portland clinker-based cements without retarding sulphate carriers, high early strengths can be measured in BCT cements.

A big advantage of BCT cements is thus that neither the cement nor the building material produced from it necessarily require hardening-controlling admixtures. However, it is within the scope of the invention to further optimize the properties by the additional use thereof.

Accordingly, one or more admixture(s) may also be contained in the building material in addition to aggregate and water, and also additives are not excluded. Above all for reasons of cost, it is preferred to use no admixtures or only a few admixtures and only in small quantities.

The grinding fineness of the cement (Blaine value) is usually in the range from 2500 cm²/g up to 10000 cm²/g, preferably ranging from 3500 cm²/g to 6000 cm²/g.

The aggregate has to be adapted in terms of fineness to the 3D printing device, therefore, an aggregate having a particle size of up to 32 mm, preferably up to 8 mm, in particular up to 4 mm (sand) is generally used. It is not necessary to use a special aggregate; all aggregates approved for concrete are suitable. Therefore, sand and/or crushed sand and/or gravel and/or rocks and/or recycled aggregates of natural origin and/or from industrial production as well as combinations of two or more thereof may be used.

The weight ratio of BCT cement to aggregate is usually from 1:2 to 1:8, preferably from 1:3 to 1:5. It is substantially based on the required green strength of the building material.

The water/cement value is typically in the range from 0.25 to 0.8, preferably 0.3 to 0.5.

When using supplementary cementitious materials such as, for example, fly ash, granulated slag or microsilica, the mass ratio of BCT cement:supplementary cementitious material should be 1:0.7 to 1:0.1, preferably 1:0.3 to 1:0.2.

Commercially available concrete admixtures can be used if necessary up to the maximum dosages specified by the manufacturer. Should delaying admixtures be required against expectations, gluconates, fruit acids, phosphates, phosphonates and borates as well as mixtures thereof and, in particular, phosphates, phosphonates or borates as well as mixtures thereof can preferably be used.

Inert additives may be added in varying mass proportions, depending on requirements, in order to adjust the properties. In order to improve the green strength, commercially available fibres (steel, plastic, glass or carbonate) can be used, for example.

To elaborate the design, commercially available concrete pigments based on carbon black for black or based on iron oxide likewise for black as well as red, brown or yellow concrete can be used. Chromium dioxide-based pigments can be used to obtain green concrete and titanium dioxide (optically inactive) to lighten the predominant grey tone.

A photocatalyst, in particular catalytically active titanium dioxide, can be added in order to achieve air quality improvements by reducing NOₓ on the building element surface.

All pigments or other additives are used in the amounts usual for concrete.

The building material used according to the invention therefore comprises at least BCT cement, aggregate and water and can consist of these. Optionally at least one of supplementary cementitious material, admixture and additive is additionally contained. Supplementary cementitious material(s) are preferably contained. One or more retarding or accelerating admixture(s) are added only if necessary.

This building material is provided according to the invention and formed by means of a 3D printer into a building element (e.g. walls, ceilings, floor panels) or building. The printer must of course be adapted to the elements to be manufactured and to the building material as material. Such printers are known.

The method according to the invention thus allows to produce building elements and buildings quickly and according to individual plans using 3D printing. No moulds are required. There is also no or very little waste. Compared to the known contour crafting and the building materials known, for example, from CN 104 310918 A, the BCT cement-based building material is more cost effective and more simple. Since fewer components are required, errors in mixing (dosing) are minimised. Complex control and adjustment of the amounts of various admixtures are also omitted. It is possible to work with only one building material.

The invention is to be explained with the aid of the following examples, but without being limited to the specifically described embodiments. Unless otherwise specified or unless the context requires otherwise, percentage values relate to the weight, and, in case of doubt, the total weight of the mixture.

The invention also relates to all combinations of preferred embodiments, insofar as these are not mutually exclusive. The specifications “about” or “approx.” In connection with a numerical figure mean that values that are higher or lower by at least 10%, values that are higher or lower by 5% and in each case values that are higher or lower by 1% are included.

### EXAMPLE 1

The start and end of setting according to DIN EN 196 part 3 and strengths after 1, 2, 7, 28 and 90 days according to DIN EN 196 part 1 were determined on two sample series for a BCT cement. The BCT cement had the following composition according to X-ray fluorescence analysis:

| Component | Weight [% by weight] |
|---|---|
| Ignition loss | 1.01 |
| SiO₂ | 17.95 |
| Al₂O₃ | 15.58 |
| TiO₂ | 0.60 |
| MnO | 0.04 |
| Fe₂O₃ | 3.23 |
| CaO | 51.48 |
| MgO | 0.96 |
| K₂O | 0.68 |
| Na₂O | 0.12 |
| SO₃ | 7.16 |
| P₂O₅ | 0.21 |
| Total | 99.1 |

The main phases were 24.8% by weight ye'elimite (C₄A₃$), 52.4% by weight belite (β-C₂S) and 8.7% by weight ferrites (C₄AF/C₂F). The cement was mixed with sand in accordance with DIN EN 196 part 1 at a ratio of 1:3 and the mixture was mixed with water at a ratio of cement:water of 1:0.5.

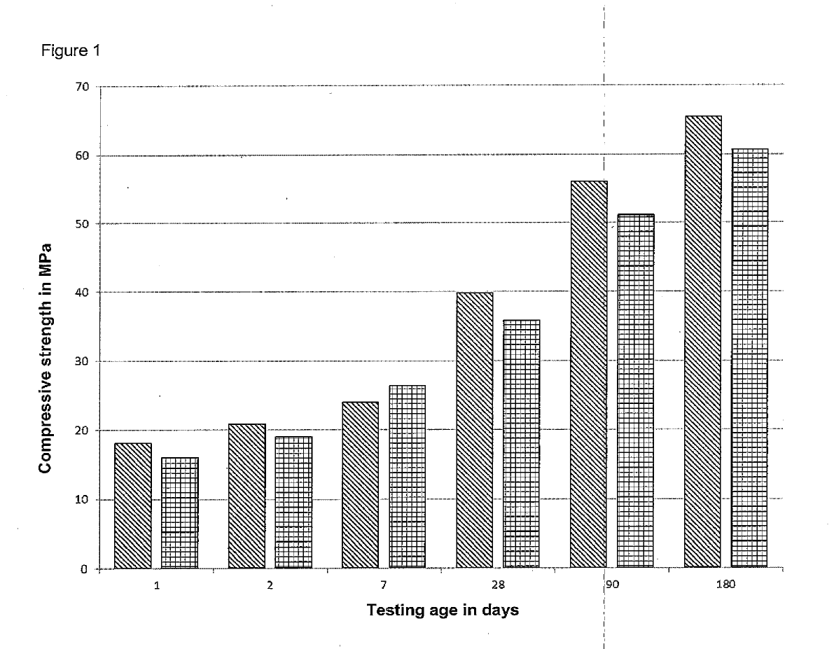

The start of setting was at 20 minutes and the end of setting at 30 minutes. The measured compressive strengths are shown in FIG. 1. Two series were measured, each with three samples, such that each of the two displayed values for one point in time represents an average of 6 measurements.

The measured strengths show that, even without the addition of retarding or accelerating admixtures, sufficient strength is achieved quickly and the final strength results in statically stable building elements or buildings even without reinforcement or other measures.

What is claimed is:

1. A use of belite calcium sulfoaluminate ternesite cement as a building material for the production of building elements and buildings by means of 3D printing.

2. Use according to claim 1, wherein the belite calcium sulfoaluminate ternesite cement contains
5 to 75% by weight C₅S₂$
5 to 70% by weight C₄A₃$
1 to 80% by weight C₂S and
0 to 30% by weight secondary phases
wherein the total of all phases contained is 100% by weight.

3. The use according to claim 1, wherein the secondary phases in belite calcium sulfoaluminate ternesite cement are one or more of calcium silicates, sulphates, calcium aluminates, spinels, representatives of melilite group, periclase, free lime, quartz and/or a glass phase.

4. The use according to claim 1, wherein the secondary phases are present in a proportion of 0.1% by weight to 30% and particularly preferred from 10% by weight to 15% by weight.

5. The use according to claim 1, wherein the belite calcium sulfoaluminate ternesite cement contains 10-60% by weight, in particular
20-40% by weight C₅S₂$, 10-60% by weight, in particular
20-45% by weight C₄A₃$ and 10-65% by weight, in particular 20-50% by weight C₂S.

6. The use according to claim 1, wherein at the free lime content in the belite calcium sulfoaluminate ternesite cement is below 5% by weight, in particular below 2% by weight and most preferably below 1% by weight.

7. The use according to claim 1, wherein there is an X-ray amorphous phase or glass phase in an amount of 1 to 10% by weight, preferably 2 to 8% by weight and in particular 3 to 5% by weight in the belite calcium sulfoaluminate ternesite cement.

8. A Method for the production of building elements and buildings, wherein:
a belite calcium sulfoaluminate ternesite cement is provided,
the belite calcium sulfoaluminate ternesite cement is mixed with aggregate and water to form a building material, and
the building material is formed layer by layer into the building element or building arranged using a 3D printer.

9. The Method according to claim 8, wherein sand and/or crushed sand and/or gravel and/or crushed rocks and/or recycled aggregates of natural origin and/or from industrial production with a particle size of up to 32 mm, preferably up to 8 mm, in particular up to 4 mm are used as aggregate.

10. The Method according to claim 8, wherein a weight ratio is set in the building material of belite calcium sulfoaluminate ternesite cement to aggregate in the range from 1:2 to 1:8, preferably from 1:3 to 1:5.

11. The Method according to claim 8, wherein a water/cement value is set in the building material in the range from 0.25 to 0.8, preferably from 0.3 to 0.5.

12. The Method according to claim 8, wherein at least one of a supplementary cementitious material, admixture and additive is added to the building material.

13. The Method according to claim 12, wherein supplementary cementitious materials such as fly ash, granulated slag and/or microsilica are added to the building material, preferably at a weight ratio of belite calcium sulfoaluminate ternesite cement:supplementary cementitious material in the range from 1:0.7 to 1:0.1, in particular from 1:0.3 to 1:0.2.

14. The Method according to claim 12, wherein retarding admixtures, preferably gluconates, fruit acid, phosphates, phosphonates or borates as well as mixtures thereof and, in particular, phosphates, phosphonates or borates as well as mixtures thereof, are added to the building material.

15. The Method according to claim 12, wherein fibres, in particular made from steel, plastic, glass and/or carbonate, are added to the building material as additives.

16. The Method according to claim 12, wherein one or more concrete pigments and/or photocatalysts are added to the building material as additives.

17. The Method according to claim 8, wherein the belite calcium sulfoaluminate ternesite cement is provided by mixing calcium sulfoaluminate cement and ternesite cement, which was obtained by sintering raw meal made from raw materials providing at least CaO and SiO₂ at temperatures of 900 to 1300° C.

18. The Method according to claim 8, wherein the belite calcium sulfoaluminate ternesite cement is provided by grinding a belite calcium sulfoaluminate ternesite clinker, wherein the belite calcium sulfoaluminate ternesite clinker is obtained by sintering raw meal made from raw materials providing at least CaO, SiO₂ and Al₂O₃ in a temperature range from >1200° C. to 1350° C., tempering a clinker intermediate product thereby obtained in a temperature range from 1200° C. to a lower limit of 750° C. to form the belite calcium sulfoaluminate ternesite clinker and cooling the belite calcium sulfoaluminate ternesite clinker.
